(19) United States
(12) Patent Application Publication
(10) Pub. No.: US 2025/0387765 A1
(43) Pub. Date: Dec. 25, 2025

(54) SYSTEM AND PROCESS FOR CHEMICAL CLEANING IN PLACE

(71) Applicant: Viking CIP Ltd., Stony Plain (CA)

(72) Inventor: Martin Luc Popiel, Stony Plain (CA)

(21) Appl. No.: 19/244,308

(22) Filed: Jun. 20, 2025

Related U.S. Application Data
(60) Provisional application No. 63/662,004, filed on Jun. 20, 2024.

(51) Int. Cl. B01F 25/53; B01F 33/05; B01F 33/502; B01F 101/24

(52) U.S. Cl. CPC B01F 25/53; B01F 33/051; B01F 33/5023; B01F 2101/24

(57) ABSTRACT

A heavy industrial mobile CIP system, which comprises two closed loops and facilitate uniformity in chemical mixing and in heating of cleaning fluid and chemical concentration. The first loop comprises an electric pump for pumping fluid from a mixing tank and through the first loop. The cleaning chemicals are added to the fluid circulating in the first loop prior to the fluid returning to the mixing tank. The cleaning fluid is heated in the mixing tank by at least one heater. The second loop comprises a second pump to pump fluid from the mixing tank through the second loop, which is connected to the equipment to be cleaned. The fluid and debris from cleaning the equipment circulates through the second loop to the mixing tank. In some cases, a weir can be used to facilitate separation of solids in the fluid returning from the equipment into the mixing tank.

### CROSS REFERENCE TO RELATED DOCUMENTS

This application is a non-provisional patent application of and claims the benefit of U.S. Provisional Patent Application No. 63/662,004 titled “System and Process for Chemical Cleaning in Place” filed Jun. 20, 2024. The disclosure of this Provisional Patent Application is incorporated by reference herein in its entirety.

### FIELD OF THE DISCLOSURE

The present application relates to a system and process for mobile chemical cleaning in place. More specifically, the application relates to a system and process for mobile chemical cleaning in place in industrial settings.

### BACKGROUND

Heavy industrial mobile clean-in-place (“HIMCIP”) is a process which uses chemicals, heated to specific temperatures, for cleaning the interior surfaces of pressure vessels, and other similar industrial equipment, without disassembly. HIMCIP is important for equipment maintenance to remove debris that builds up in pressure vessels and causes bottlenecks in the production capabilities of a facility and other processes, and which can result in damage to system components. Without regular cleaning the debris build up can lead to costly shutdowns to make repairs to entire systems or specific components within the system.

When cleaning is required, the HIMCIP system is brough to the location of, and connected with, the pressure vessel or similar equipment. A significant amount of time and effort is required to mobilize and demobilize a traditional HIMCIP system on site.

There are four main elements that contribute to the chemical cleaning process. These are 1) cleaning fluid temperature, including the temperature of the cleaning chemical during the pre-mixing and application stages; 2) the method of mixing the chemicals; 3) application of the cleaning chemical to the equipment; and 4) the cleaning product itself. Current chemical cleaning processes have seen little change to any of these elements in the past 40 years.

Traditionally, a power takeoff (“PTO”) mechanical or hydraulic power source is used to power a pump that moves water from a water tank to a coil burner to be heated, and then through a rubber hose to a hopper, where chemical is added to the heated water. A second rubber hose is then used to transport the cleaning solution to the piece of equipment to be cleaned. The cleaning solution travels out of the piece of equipment and back to the water tank to start the cycle all over again. In this single, closed loop system design, 100% of the contaminants cleaned from the equipment are recirculated within the system as cleaning continues. Flow through the current system is not consistent, but rather fluctuates because the RPMs of a PTO motor change for a variety of reasons, which ultimately results in an inconsistent flow of fluid in traditional HIMCIP systems.

Because HIMCIP is a chemical cleaning process, rather than an abrasion cleaning process, controlled heating and mixing of the chemical starting material prior to injecting the cleaning fluids into the equipment is critical to success of the cleaning process and the long term viability of the equipment. These important elements of the process are nearly impossible to control with any consistency when running a pump off a PTO power supply, for example a tractor motor.

As noted, heating is a critical element of the cleaning process. Current systems use a coil burner with an open flame for heating. While this method is able to heat liquid at a faster rate than using, for example an electric heater, this traditional method provides very inconsistent heating of the cleaning fluid and neutralizes a significant portion of the cleaning chemical by boiling it during the heating process. This occurs, for example, when using nitric acid, which vaporizes at 83° C. Diesel flame, in comparison, operates at ˜2,000° C. to ˜2,300° C., so a large percentage of the purchased chemical in the cleaning fluid heated by a coil burners, which sit at very high temperatures, is vaporized before entering equipment to be cleaned due to excessive and uncontrolled heating of the cleaning fluid before use. In another example, toluene, a common solvent used to strip heavy oil, has a boiling point of 110° C. and when exposed to the coil burners at substantially higher temperatures then its boiling point, flashing of the toluene occurs. Unfortunately, this is unavoidable when using open flame heaters to heat the fluid from ambient temperature to application temperature.

Mixing of the starting material with the circulating fluid prior to application is another challenge in current chemical cleaning processes. The fundamental chemistry of the cleaning process requires that the base medium be at a prescribed temperature before adding the active agent, for example, sodium hydroxide and nitric acid, among others. When the cleaning chemicals are exposed directly to a flame based heating coil, as is the traditional method, the effectiveness of the cleaning chemical is compromised because the temperature of the mixture isn't consistent throughout the solution and loss of some chemical components can result in changes to the ratio of chemicals in the circulating fluid. If the proportions of the chemical agents in the circulating fluid are not at the correct ratio at the correct temperature then one of two things can occur during the cleaning cycle; a residue can be left on the equipment being cleaned, thereby impeding performance; or the surface which is contacted during cleaning (for example a carbon metal coating) is compromised due to over exposure to certain chemicals and the long term life and operating capabilities of the equipment is compromised.

Additionally, in traditional methods the starting material is added to the heated circulating fluid by way of a hopper located on the ground and in not mobile. Adding the chemical starting material to the circulating fluid at this point in the cycle results in a chemical reaction occurring within the transfer hose. This can be problematic because different elements of the chemical starting material expand at different ratios when heated. The chemical transfer hose is not designed to contain the temperature and pressure changes that can happen when the chemical starting material mixes with the heated circulating fluid. Therefore, burst failures of the hose often occur, resulting in spills on site.

As described above, current HIMCIP designs have two large greenhouse gas (“GHG”) emission sources. The PTO motors, for example highway tractor diesel motors, used to power the pump to circular the cleaning fluid and the use of diesel fuel to supply the flame to the coil burner used to heat the circulating fluid. These two elements are the main producers of GHG emissions in the current HIMCIP process, and each of these elements are designed to run for the duration of each cleaning event. This is undesirable for companies who are heavy GHG emitters and actively looking for ways to meet environmental sustainability targets.

### SUMMARY

In one aspect, there is provided a system for use in heavy industrial mobile cleaning in place comprising: a mixing tank, a first loop fluidly connected at both ends to the mixing tank wherein a first electric pump circulates fluid through the first loop and a second loop which fluidly connects the mixing tank to a piece of equipment and then back to the mixing tank, wherein a second electric pump circulates fluid through the second loop, wherein a starting material is mixed with the circulating fluids within the first loop.

In some embodiments, the first and second electric pumps are independently activated and/or controlled. In some embodiments, the system further comprises at least one heater disposed within the mixing tank. In some embodiments, the at least one heater is an electric heater and in some embodiments the at least one heater is removable.

In some embodiments the system further comprises a hopper connected to the first loop via a conduit.

In some embodiments, the system further comprises a weir attached to the floor of the mixing tank. In some embodiments, the floor of the mixing tank has at least one sloping surface.

In some embodiments, the first electric pump comprises a valve movable between a first and second position. In some embodiments, the system further comprises comprising a movable platform for moving the system as a unit.

In another aspect, a process is provided for heavy industry mobile cleaning in place, the process comprising providing a system comprising a mixing tank, a first loop and a second loop, coupling a piece of equipment to the second loop such that the mixing tank, first loop, second loop and piece of equipment are all fluidly connected, pumping circulating fluid through the first loop using a first electric pump, adding a starting material to the circulating fluid within the first loop by way of a conduit, and pumping circulating fluid through the second loop and the piece of equipment using a second electric pump.

In some embodiments, the first and second electric pumps are independently activated and/or controlled.

In some embodiments, the process further comprises heating the circulating fluid using at least one heater disposed within the mixing tank. In some embodiments, the at least one heater is an electric heater.

In some embodiments, the starting material is added to the circulating fluid via a hooper which is connected to the first loop via a conduit.

In some embodiments, the first electric pump comprises a valve with first and second positions. In some embodiments, the process further comprises switching from pumping the circulating fluid within the first loop to suctioning sediment out of the mixing tank by moving the valve from the first position to the second position.

In some embodiments, the first electric pump is turned on and off intermittently while the second electric pump continues to pump circulating fluid through the second loop.

In some embodiments, the process further comprises monitoring the temperature of the circulating fluid and turning on or off the at least one heater to maintain the circulating fluid temperature within a predetermined temperature range.

In some embodiments, the mixing tank contains one or more waste outlets to allow for the removal of sediment.

Other aspects and features of the present disclosure will become apparent to those ordinarily skilled in the art, upon review of the following description of the specific embodiments of the disclosure.

### BRIEF DESCRIPTION OF THE DRAWINGS

The present disclosure will be better understood having regard to the drawings in which:

FIG. 1 is a flow diagram of the traditional CIP process;

FIG. 2 is a flow diagram illustrating the invention described herein;

FIG. 3 is a right perspective view of one embodiment of a CIP apparatus as described herein;

FIG. 4 is back perspective view of the embodiment shown in FIG. 3;

FIG. 5 is a left perspective view of the embodiment shown in FIG. 3;

FIG. 6 is a side perspective view of the embodiment shown in FIG. 3;

FIG. 7 is a close up right perspective view of the embodiment shown in FIGS. 3; and

FIG. 8 is a perspective view of the water and mixing tank of the embodiment shown in FIG. 3.

### DETAILED DESCRIPTION

In this disclosure the term “starting material” is used herein to refer to the cleaning chemical that is introduced into the system, prior to it being mixed with the circulating fluid. The starting materials can be either a liquid or a powder. The term “cleaning chemical” is used herein interchangeably with “starting material”.

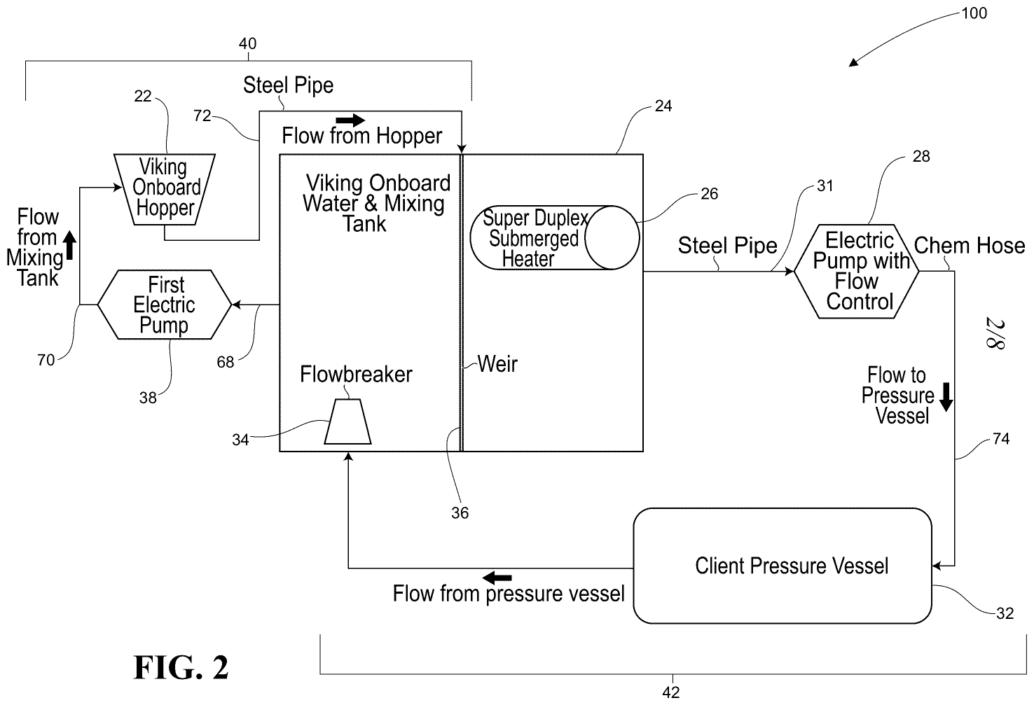

The term “circulating fluid” refers the liquid that circulates within the CIP system shown in FIG. 2 and refers to the water present in the system prior to the addition of any of the starting material and to the fluid circulating in the CIP system after the starting material has been added. The term “cleaning fluid” is used herein to refer specifically to circulating fluid that includes a mixture of both the starting material and water. Therefore, in many instances herein the terms “circulating fluid” and “cleaning fluid” are interchangeable, except where it is clear that the circulating fluid does not contain any starting material.

The term “returning fluid” as used herein refers specifically to the circulating fluid that has left the equipment 32 and returned to the mixing tank 24 through the second inlet. The returning fluid may contain solid particles that have been cleaned out of the equipment, along with the cleaning fluid.

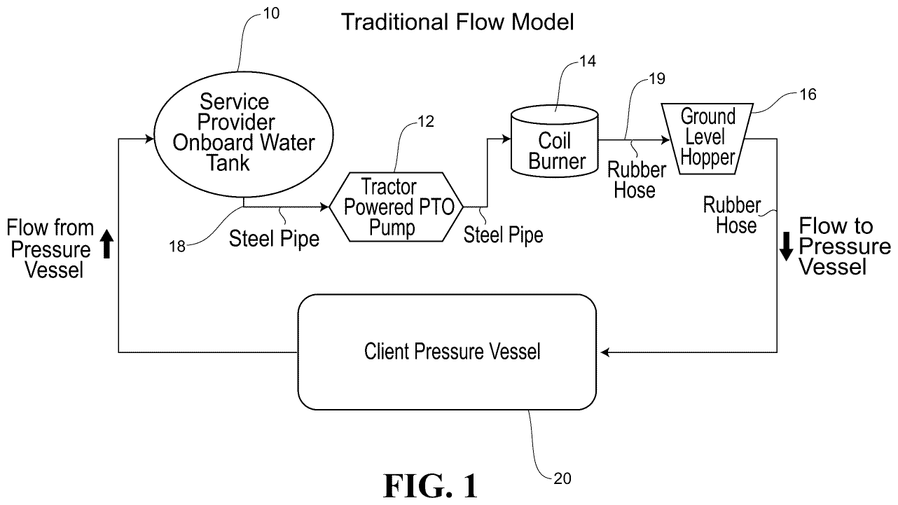

Referring to FIG. 1, the flow diagram for a traditional CIP process is shown. In use, water from the water tank 10 moves through connecting pipe 18 to a PTO pump 12, which then pumps the water to a coil burner 14. As is known in the art, the coil burner 14 uses an open flame to heat coils, which in turn heats the circulating fluid to an application temperature. A rubber hose 19, fluidly connects the coil burner 14 to the hopper 16. The starting material is added to the circulating fluid via the hopper 16. A second rubber hose is then used to transport the cleaning fluid to a first connection point on a piece of equipment 20. Therefore, in the traditional method, the starting material and circulating fluid mix to form the cleaning chemical within the second rubber hose.

Another chemical composite hose is connected to a second connection point on the piece of equipment 20, which takes the cleaning fluid back to the water tank 10.

The cleaning fluid continues to be circulated in this manner, such that the fluid and any solids cleaned from the equipment move through the single closed loop process for a prescribed period of time to complete the cleaning process.

One embodiment of the mobile HIMCIP process described herein is shown in FIG. 2. The process, 100, shows two distinct circulation loops. The first loop 40, fluidly connects at both ends to the mixing tank 24 and a first electric pump 38 circulates fluid through the first loop 40. The first loop 40, functions to provide a consistent flow of circulating fluid so that the addition of starting material to circulating fluid happens in a controlled fashion. The second loop 42 fluidly connects the mixing tank 24 to a piece of equipment 32 and then back to the mixing tank 24 and a second electric pump 28 circulates fluid through the second loop 42. The second loop 42 functions to provide consistent and controlled heating of the cleaning fluid and circulation of the cleaning fluid to and through the piece of equipment 32. The first and second electric pumps 38, 28, can being activated and/or controlled independently, such that one electric pump may be turned on, while the other is turned off.

A first electric pump 38 regulates the flow of the circulating fluid through the first loop 40. Circulating fluid enters the first connecting pipe 68 from the mixing tank 24 and travels through the first electric pump 38 to the second connecting pipe 70. Cleaning chemicals, also referred to as the starting material, are added to the circulating fluid in the first loop. In some embodiments the cleaning chemicals are fed into a hopper 22 then travel via a conduit to a hopper connection point 66 where they meet the circulating fluid. While a hooper is shown in the figures, cleaning chemicals can be added to the circulating fluid directly into one of the pipes in the first loop 40 or via a conduit without the use of a hooper. The starting material fed into the hopper can be in liquid or solid form.

The circulating fluid, with the cleaning chemicals, then travels back to the mixing tank 24 through a third connecting pipe 72. In some embodiments as the circulating fluid travels back to the mixing tank 24, it may be incrementally heated as a result of turbulence as the circulating fluid travels through the first loop 40. The cleaning fluid continues to mix in the mixing tank 24 and, in the preferred embodiment, the mixing tank 24 remains at or around atmospheric pressure throughout the cleaning process. This design provides for a more chemically consistent circulating cleaning fluid than traditional methods.

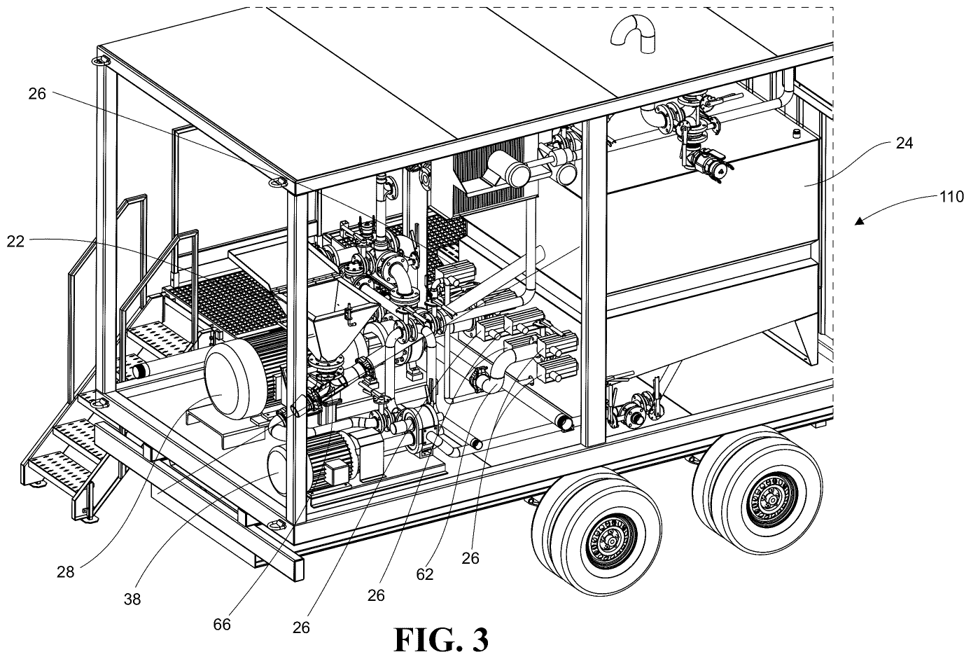

As noted above, the starting material can be introduced into the circulating fluid via a conduit connected to the hopper 22. As shown in FIG. 3 in one embodiment of the present invention the hopper 22 is located on a fixed platform as part of the mobile system and therefore is able to conveniently travel with the rest of the HIMCIP system. Additionally, the mounting of the hopper 22 above ground level and, in some embodiments over a containment area, reduces the risk of spills on site.

While the hopper connection point 66 in FIG. 3 is shown directly below the hopper 22, the hopper connection point 66 can be anywhere downstream of the first electric pump 38 in the first loop 40. In some embodiment, the hopper connection point 66 can be upstream of the first electric pump 38. Where the hooper is not used, the point in the first loop where the starting material is added can be before or after the first electric pump 38. Once the circulating fluid has travelled back to the mixing tank 24, the starting material and circulating fluid are able to fully combine and be heated to the application temperature or within the application temperature range, prior to the cleaning chemical being circulated through the second loop 42 to the equipment 32. In some embodiments, the turbulence created by the first electric pump 38 can also function to assist with the mixing of the starting material and the cleaning fluid to create a substantially homogenous mixture within the mixing tank 24.

As a result of the initial chemical reaction being contained within the first loop 40, it is unlikely that a hose blowout will occur as the result of an expanding reaction in a chemical transfer hose.

Located within the mixing tank 24 is at least one heater 26, which functions to heat the cleaning fluid to a specific application temperature or to within a specific application temperature range. In a preferred embodiment, each of the at least one heater 26 is an electrical heater. The at least one heater 26 can be controlled by a programmable logic controller (not shown). The programmable logic controller can also monitor the temperature and/or pressure measurement readings from within the mixing tank 24 and turn on or off the at least one heater 26 in order to maintain the circulating fluid within a specific application temperature range, or at a specific application temperature.

The application temperature or application temperature range is chosen to increase the speed of the any chemical reaction taking place during the process 100. The specific temperature or temperature range chosen is based on the chemicals being used for treatment and based on the viscosity and density of the cleaning solution. For example, when the cleaning fluid contains either bases or acids, the temperature/temp range can be 5° C. and 95° C.

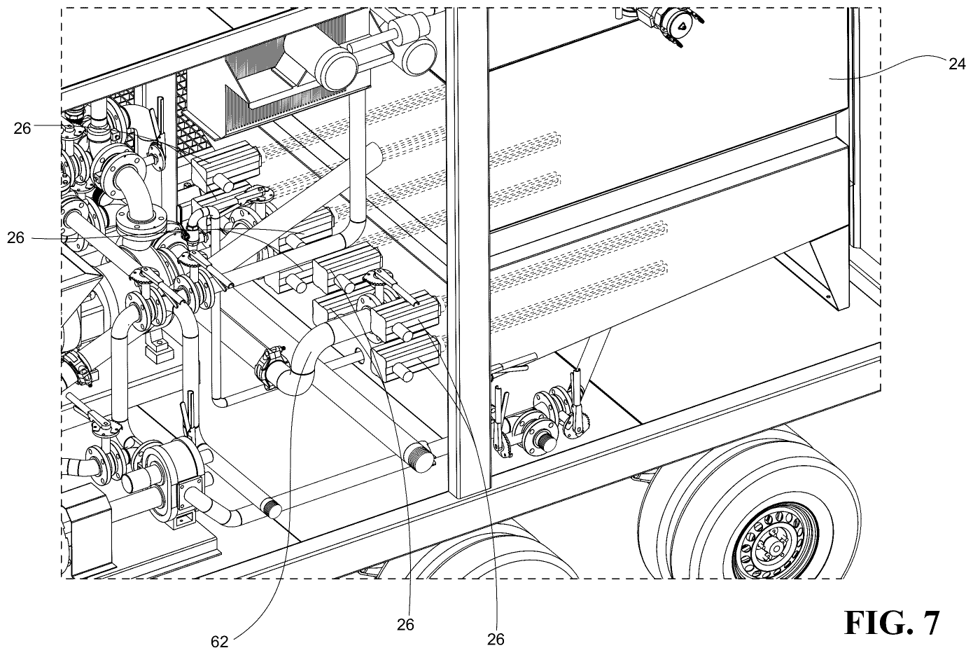

The electrical heating element of the at least one heater 26 is disposed within the mixing tank 24. In some embodiments the heater or heaters can extend inwardly through one of the at least one opening 48 in the side of the mixing tank 24 in the lower half of the mixing tank 24. In the example shown in FIG. 7, there are eight electric heaters, all located below the top edge of a weir 36. The spacing of each of the at least one heater 26 can vary based on the structure of the mixing tank 24 and the heating requirements. The preferred substantially symmetrical arrangements of at least one heater 26 promotes turbulence and mixing, by creating a fluid eddy and vortex elimination, and promotes uniform heating.

While electric heaters are not as efficient at heating fluid as a coil burner, they provide a controlled and consistent heating of the circulating fluid. In some embodiments eight electric heaters produce 15 KW of heat energy or 8×15 Kj/min.

Electric heaters do not degrade the pipe or vessel holding the chemical fluid that is being heated and substantially reduces or eliminates loss of chemicals to vaporisation or flashing as compared to using a coil burner.

From the mixing tank 24, the cleaning fluid enters the second loop 42 through a second outlet, and travels via a fourth connecting pipe 31 to a second electric pump 28. The second electric pump 28 controls the flow of cleaning fluid through the second loop 42 and can function independently of the first electric pump 38. The second inlet 44 to the second loop 42 constitutes the entry point to the second electric pump 28. Whereas return inlet 46 constitutes all fluid returns to the mixing tank 24 beneath the weir 36 prior to flow breaker 34.

After passing the second electric pump 28, the cleaning fluid moves through a chemical hose 74 to a first equipment connection point on the piece of equipment 32. The cleaning fluid circulates within the equipment 32, cleaning it, and then exits the equipment 32 through a second equipment connection point. The returning fluid, containing cleaning fluid and any debris and/or particulates cleaned from the piece of equipment 32, travels through a fifth connecting pipe 62 back to the mixing tank 24.

Using independent electric pumps in both the first and second loops, 40, 42 to power the movement of the fluid through the HIMCIP system, provides a consistent flow of fluid through both the first and second loops, 40, 42. A consistent flow of fluid is important for maintaining consistent system pressure and allowing greater entrainment of heavy particles. Inconsistent flow and pressure inhibits the settling of solids at the bottom of the mixing tank 24.

At least the mixing tank 24, first connecting pipe 68, first electric pump 38, second connecting pipe 70, the hopper connection point 66 and the third connecting pipe 72 form the first loop 40. In some embodiments the hopper 22 is also included as a component of the first loop 40. The second loop 42 includes at least the mixing tank 24, fourth connecting pipe 31, second electric pump 28, chemical hose 74, piece of equipment 32 and fifth connecting pipe 62.

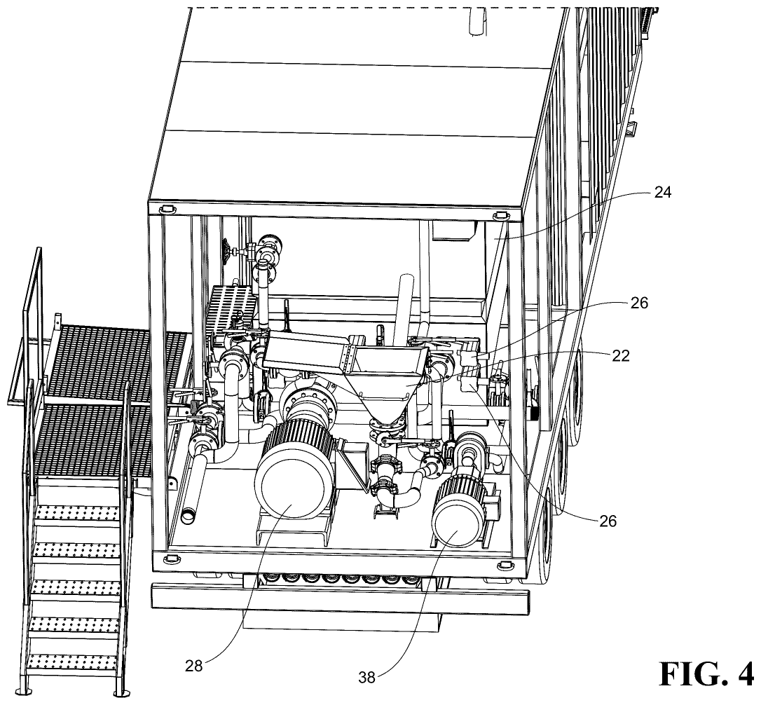

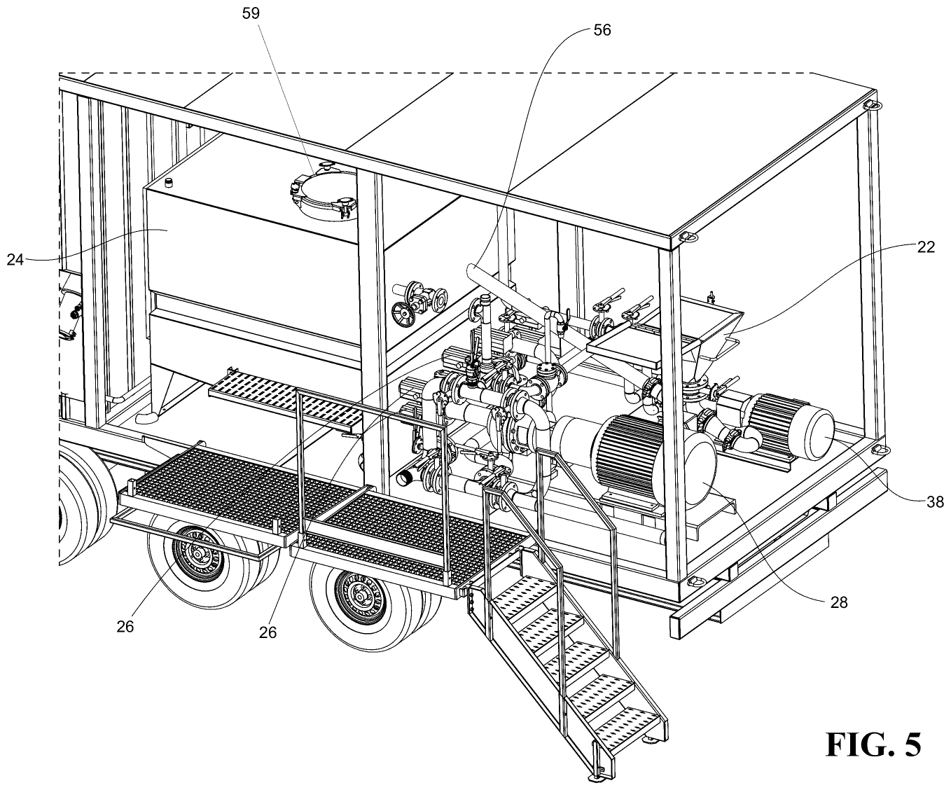

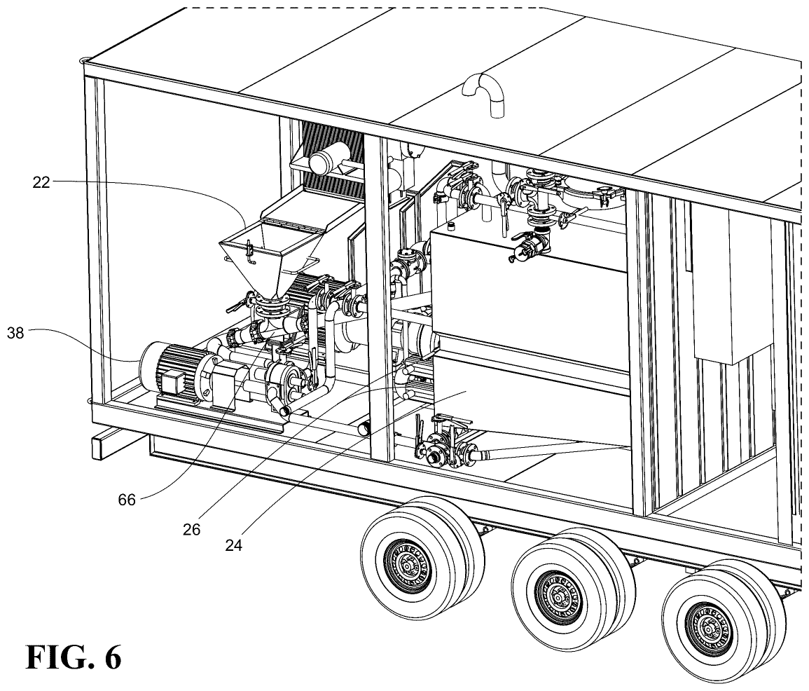

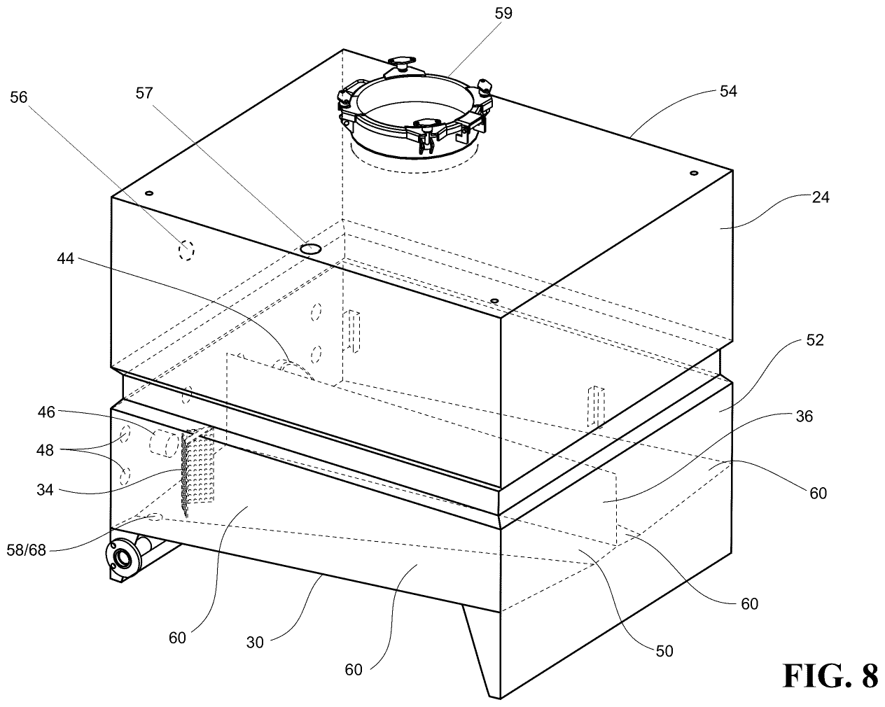

FIGS. 3 to 6 show the mixing tank 24 in relation to the other elements in the first and second loops, 40, 42, while FIGS. 7 and 8 show the mixing tank 24 in more detail. As shown in FIGS. 3 to 6, in some embodiments the first and second loops, 40, 42, are separate loops and fluid circulates through each of these loops independently as a result of the activation of either the first or second electric pump, 38, 28.

Referring to FIG. 8, in a preferred embodiment the mixing tank 24 can be substantially cubic or substantially cuboidal in shape having a top and a bottom, as well as first and second opposing sides, and third and fourth opposing sides. In other embodiments the mixing tank 24 can be egg shaped or cylindrical, having generally opposing sections, rather than opposing side, but which are considered herein to be equivalent. The mixing tank 24 can also have a first outlet 58 and first inlet 56.

In some embodiments the mixing tank 24 can have at least one waste outlet to allow for the removal of any sediment that may collect on the bottom of the mixing tank 24. The at least one solid waste outlet can be located in the bottom or floor 30 of the mixing tank 24. In some embodiments there is a weir 36 that is generally symmetrically located between second inlet 44 and return inlet 46 to ensure that particles with specific gravity greater than the cleaning fluid settle to the bottom of the mixing tank 24. The first outlet 58 can be located generally proximate to the top of the mixing tank 24. The at least one solid waste outlet is fluidly connected to the first electric pump 38 to allow the first electric pump 38 to pull solid waste out of the mixing tank 24 via the at least one solid waste outlet.

In some embodiments the mixing tank 24 can have a vent 57 used for pressure relief as needed. In some embodiments the mixing tank 24 can also have a non-pressurized lid 59.

The mixing tank 24 can have three areas, a first lower area 50, a second lower area 52 and an upper area 54. In some embodiments a weir 36 can be located in the lower portion of the mixing tank 24 and can separate the first and second lower areas 50, 52. In some embodiments the weir 36 is attached to the floor of the mixing tank 24. The mixing tank 24 has at least one opening 48 for the at least one heater 26. Typically, each heater has a corresponding opening. In some embodiments all of the at least one opening 48 are located below the top edge of the weir 36. In some embodiments the at least one heater 26 can extend inwardly from the any side wall of the tank. The electrical heating element of the at least one heater 26 should be positioned sufficiently distanced from the side wall of mixing tank 24 that it does not cause heating of the side wall to the extent that the heating substantially affects the structural integrity of the side wall of the mixing tank 24. In some embodiments the distance between the heating element of the at least one heater 26 and the side wall of the mixing tank 24 is approximately 2 inches. In a preferred embodiment there is more than one heater, and the heaters are distributed in a lattice type arrangement.

Each of the at least one heater 26 can be individually removed and changed in the event they stop working and need to be repaired or replaced, or in the event that the heater needs to be changed or removed or any other reason. For example, pre-heated water from a nearby plant or facility may be used in the system and therefore, fewer heaters may be required to heat the circulating fluid and/or maintain the temperature of the circulating fluid. If a heater needs to be removed and is not replaced, the associated at least one opening 48 can be sealed to prevent leakage during subsequent usage. In some embodiments, one or more heaters can be inserted to increase heating power in certain applications. In a preferred embodiment the heater(s) are screw plugs.

When present, the weir 36 functions to facilitate the separation of solids that have a specific gravity greater than the circulating fluid from the returning fluid. This reduces the potential for solids to circulate throughout the system. Generally speaking, the weir 36, with the aid of flow breaker 34, facilitates the separation of solids from the cleaning fluid by reducing the turbulence of the fluid at the return inlet 46, which allows solids with a specific gravity greater than the circulating fluid to settle at the bottom of the mixing tank 24.

The weir 36 shown in FIG. 8 is positioned along approximately the center line of the mixing tank 24 and extends upwardly from the floor 30 of the mixing tank 24 to above the position of the submerged at least one heater 26. However, the exact position and upward angle of the weir 36 can vary as long as it functions to facilitate the separation and settling of solids in the returning fluid.

In some embodiments the weir 36 is attached to the floor 30 of the mixing tank 24. In some embodiments the weir 36 can extend upwardly between approximately 30% to approximately 50% of the height of the mixing tank 24. In some embodiments, the weir 36 can be up to around one third of the total height of the mixing tank 24. In some embodiments the weir can be positioned to ensure it is at least about 2 inches from the at least one heater 26. In some embodiments the weir 36 can be removably attached to the floor 30 of the mixing tank 24.

In some embodiments the floor 30 of the mixing tank 24 can include at least one sloping surface 60. These sloping surfaces can function to direct settled or settling solids towards a specific location in the mixing tank 24. For example, the at least one sloping surface 60 can direct solids towards at least one solid waste outlet 58.

In some cases, different parts of the floor 30 may slope inwardly towards each other and downwardly towards a solid waste outlet to funnel sediment to one or more locations within the mixing tank 24. In some embodiments, part of the floor 30 of the mixing tank 24 can be sloped towards the first solid waste outlet 64 so that sediment is directed to the first solid waste outlet 64 and may be removed from the mixing tank 24 as needed. For example, the floor 30 may slope downwardly from a side of the mixing tank 24 at an approximate angle of anywhere from about 15° to about 45°. In some embodiments the floor 30 may slope downwardly at an approximate angle of about 15°, about 30° or about 45°.

In some embodiments, for example as shown in FIG. 8, the floor 30 of the mixing tank 24 can have four sloping surfaces, two in each of the first and second lower areas, 50, 52, of the mixing tank 24 as well as two solid waste outlets (64 and not shown). The inward angle of the sloping surfaces can range from about 90° downwards to about 0° upwards, as long as the application and design allows for a slope.

Attached to the first and second solid waste outlets, 64 and not shown, is a waste pipe (not shown), which carries settled sediment from the mixing tank 24 to a truck or holding tank.

At certain points during operation of the system, an operator may turn a first valve that is functionally connected to the first electric pump 38 so that when the first valve is in a first position the first electric pump 38 pumps circulating fluid through the first loop 40 and when the valve is in a second position the first electric pump 38 suctions sediment out of the mixing tank 24 through the at least one solid waste outlet.

If an operator wants to remove sediments from the mixing tank 24, they can turn the first valve to the second position. Once an amount of sediment has been removed from the mixing tank 24, the operator can then turn the same valve to the first position so that the first electric pump 38 is ready to pump circulating fluid through the first loop 40.

The mixing tank 24 may include a sight window (not shown) that allows an operator to see the level of sediment within the mixing tank 24 so they can determine when to turn the first valve to the second position so that the first electric pump 38 can begin removing sediment. The sight window may be made of glass or polymer. In a preferred embodiment the sight window extends substantially along the side of a wall of the mixing tank 24. In another embodiment the sight window extends substantially the height of the mixing tank 24.

In some embodiment the mixing tank 24 can also include a flow breaker 34. In FIG. 8 the flow breaker 34 is positioned near the return inlet 46, where returning fluid enters the mixing tank 24 from the equipment 32. The flow breaker 34 functions to reduce turbulence within the mixing tank 24. The flow breaker 34 can be made of a variety of materials, however in a preferred embodiment the flow breaker 34 is made from the same material as the other wetted parts of the system 110, in order to avoid undesirable chemical reactions.

While the shape of the flow breaker 34 in FIG. 8 is shown to be two walls positioned at an acute angle to each other, the shape and relative positioning of the element(s) of the flow breaker 34 can vary as would be known to a skilled person. In some embodiments the flow breaker 34 can include holes spaced at regular or irregular intervals in one or both of the walls. The size and location of the holes in the walls of the flow breaker 34 can vary as would be known to a skilled person.

In some embodiments, all elements of the HIMCIP system are able to fit onto a moveable platform and have a smaller overall footprint than current HIMCIP systems, in part because it is electrically powered. In cases where the system is able to fit onto a moveable platform, the moveable platform allows the system to be moved as a unit, for example into and out of position adjacent to the piece of equipment to be cleaned.

Use of electricity (shore power) to power the first and second electric pumps, 38, 28, eliminates the need for diesel tractor highway motors and the integration of electric heaters in the mixing tank 24 eliminates the need for open flame heating onsite. These improvement to the HIMCIP system provide substantial GHG emission savings as shown in Table 1, although it is noted that the source of electricity determines the actual final reduction in GHG emissions.

TABLE 1

| | Conventional | | Conventional | | VCIP | | VCIP | |
|---|---|---|---|---|---|---|---|---|
| | Tractor Diesel | | Diesel Coil | | (Shore | | (Tier 4 Diesel | |
| | Motor | | Heater | | Power) | | Generator) | |
| Diesel | 11 | USG/hr | 2 | USG/hr | 0 | USG/hr | 6 | USG/hr |
| Consumption | | | | | | | | |
| CO₂ | 244 | lbs/hr | 244 | lbs/hr | 0 | lbs/hr | 133 | lbs/hr |
| Emissions | | | | | | | | |

| | | |
|---|---|---|
| Total Emission Reductions | 100% | ~46% |

The HIMCIP system can improve safety conditions for onsite employees by: 1) elimination of open flame heating sources; 2) integration hopper feed system for chemical loading; and 3) the sound attenuation design of the mobile units.

When in use the HIMCIP process involves placing the cleaning chemical in the hopper 22 and water in the mixing tank 24. The first electric pump 38 is turned on and water begins to circulate within the first loop 40. The water is heated continuously through first loop 40, based on the residence time of the mixing tank volume, which is controlled by second loop 42.

As water passes the connection to the hopper 22 cleaning chemical is added to the water creating the cleaning fluid. This cleaning fluid is transported back to the mixing tank 24 where it is heated by at least one heater 26, until it reaches the application temperature or falls within the application temperature range. The temperature of the cleaning fluids is monitored by an operator via a programmable logic controller that records and transmits temperature and pressures measurement readings from within the mixing tank 24.

The first electric pump 38 can be turned on and off intermittently, depending on the cleaning requirements. For example, the first electric pump 38 may be turned on for about 5 minutes about once every 30 minutes to pump water or cleaning fluid through the first loop 40. The first electric pump 38 may also be intermittently turned on to evacuate sediment from the mixing tank 24 after the first valve is turned to a second position. The composition of the cleaning fluid is measured and monitored externally as is common industry practice.

Once the cleaning fluid has reached the application temperature or falls within the application temperature range, the cleaning fluid can be circulated through the second loop 42 by activating the second electric pump 28. In most cases, the second electric pump 28 will continue to run for the duration of the cleaning treatment.

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A system for use in heavy industry mobile cleaning in place, the system comprising:
a mixing tank;
a first loop fluidly connected at both ends to the mixing tank wherein a first electric pump circulates fluid through the first loop; and
a second loop which fluidly connects the mixing tank to a piece of equipment and then back to the mixing tank, wherein a second electric pump circulates fluid through the second loop;
wherein a starting material is mixed with the circulating fluids within the first loop.

2. The system of claim 1, wherein the first and second electric pumps are independently activated.

3. The system of claim 1, further comprising at least one heater disposed within the mixing tank.

4. The system of claim 3, wherein the at least one heater is an electric heater.

5. The system of claim 3, wherein the at least one heater is removable.

6. The system of claim 1, further comprising a hopper connected to the first loop via a conduit.

7. The system of claim 1, further comprising a weir attached to the floor of the mixing tank.

8. The system of claim 1, wherein the floor of the mixing tank has at least one sloping surface.

9. The system of claim 1, wherein the first electric pump comprises a valve movable between a first and second position.

10. The system of claim 1, further comprising a movable platform for moving the system as a unit.

11. A process for heavy industry mobile cleaning in place, the process comprising:
providing a system comprising a mixing tank, a first loop and a second loop;
coupling a piece of equipment to the second loop such that the mixing tank, first loop, second loop and piece of equipment are all fluidly connected;
pumping circulating fluid through the first loop using a first electric pump;
adding a starting material to the circulating fluid within the first loop by way of a conduit; and
pumping circulating fluid through the second loop and the piece of equipment using a second electric pump.

12. The process of claim 11, wherein the first and second electric pumps are independently activated.

13. The process of claim 11, further comprising heating the circulating fluid using at least one heater disposed within the mixing tank.

14. The process of claim 13, wherein the at least one heater is an electric heater.

15. The process of claim 11, wherein the starting material is added to the circulating fluid via a hooper which is connected to the first loop via a conduit.

16. The process of claim 11, wherein the first electric pump comprises a valve with first and second positions.

17. The process of claim 16 further comprising switching from pumping the circulating fluid within the first loop to suctioning sediment out of the mixing tank by moving the valve from the first position to the second position.

18. The process of claim 11, wherein the first electric pump is turned on and off intermittently while the second electric pump continues to pump circulating fluid through the second loop.

19. The process of claim 13, further comprising monitoring the temperature of the circulating fluid and turning on or off the at least one heater to maintain the circulating fluid temperature within a predetermined temperature range.
